(19) United States
(12) Patent Application Publication
(10) Pub. No.: US 2024/0185135 A1
(43) Pub. Date: Jun. 6, 2024

(54) SYSTEM AND METHOD FOR TRAINING A MACHINE LEARNING MODEL

(71) Applicant: Sony Interactive Entertainment Inc., Tokyo (JP)

(72) Inventors: Ryan Spick, London (GB); Guy Moss, London (GB); Timothy Bradley, London (GB); Pierluigi Vito Amadori, London (GB)

(73) Assignee: Sony Interactive Entertainment Inc., Tokyo (JP)

(21) Appl. No.: 18/513,849

(22) Filed: Nov. 20, 2023

(30) Foreign Application Priority Data
Dec. 2, 2022 (GB) 2218156.4

(51) Int. Cl. G06N 20/00

(52) U.S. Cl. CPC G06N 20/00

(57) ABSTRACT

A system for generating a training dataset for a machine learning process, and training a machine learning model, the system comprising a data obtaining unit configured to obtain training data comprising a plurality of events of interest and the behaviour of an agent corresponding to those events, an event identifying unit configured to identify, based upon one or more corresponding indicators, the occurrence of an event of interest in the training data, a list generating unit configured to generate a list of identified events in the training data, wherein identified events are added to the list with a probability that is inversely proportional to the frequency of the occurrence of that event within the training data, a dataset generating unit configured to generate a dataset comprising information about the events contained in the generated list, and a training unit configured to train a machine learning model using the generated dataset, wherein the machine learning model is trained to generate behaviour for an agent corresponding to events within the generated dataset.

### BACKGROUND OF THE INVENTION

### Field of the Invention

This disclosure relates to a system and method for training a machine learning model.

### Description of the Prior Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Interest in machine learning and artificial intelligence techniques has increased significantly in recent years, with such techniques finding applications in a wide range of subject areas. Such techniques may be considered advantageous in that they can lead to improved results versus a more rules-based program directed towards solving a particular program—for instance, through finding improved solutions to a particular problem and/or through being more adaptable to the specific parameters of new problems.

There are a number of different ways of training models in accordance with these techniques, each having their own advantages and disadvantages. For example, reinforcement learning a generally successful training approach that is considered to be particularly suitable for applications in which rewards (such as the completion of a goal) are able to be well-defined and provided at regular intervals; however, in applications where this is not the case reinforcement learning may lead to poor outcomes.

Generative adversarial networks are another popular training technique, which is particularly suited to problems such as image generation. Examples of this are seen in the recent interest in AI-generated artwork in which images are generated based upon text prompts, as well as other applications such as style transfers and photo editing. However, training such a model can be very processor-intensive and can require extensive datasets (which can be problematic in some cases).

The present disclosure considers the use of imitation learning for the training of a machine learning model. Imitation learning may be considered particularly suitable for the training of particular behaviours, for instance; typically, an expert will be used to generate training data (such as a video of them completing a particular activity) and a set of such data will be provided as a training dataset. However, there are a number of drawbacks to such a training method. For example, it may be the case that a prohibitively large dataset is required in order to train the model to be able to react appropriately in a wide range of scenarios; it can also be problematic if the dataset includes poor-quality data as this can lead to overfitting with some scenarios and underfitting in others.

It is in the context of the above discussion that the present disclosure arises.

### SUMMARY OF THE INVENTION

This disclosure is defined by claim 1.

Further respective aspects and features of the disclosure are defined in the appended claims.

It is to be understood that both the foregoing general description of the invention and the following detailed description are exemplary, but are not restrictive, of the invention.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically illustrates a method for training a machine learning model;

FIG. 2 schematically illustrates a method for generating a training dataset;

FIG. 3 schematically illustrates an example of the method of FIG. 2 as applied to the specific implementation of training a machine learning model to play a video game;

FIG. 4 schematically illustrates a system for generating and using a training dataset for a machine learning process to obtain a trained machine learning model from training data; and

FIG. 5 schematically illustrates a method for generating a training dataset for a machine learning process and training a machine learning model in accordance with generated training datasets.

### DESCRIPTION OF THE EMBODIMENTS

Referring now to the drawings, wherein like reference numerals designate identical or corresponding parts throughout the several views, embodiments of the present disclosure are described.

As discussed above, imitation learning may be considered to be particularly suitable for applications in which an agent is to learn behaviour; this can find applications in a number of areas, such as self-driving cars, navigation of an environment (real or virtual) by an agent, and playing games. It is on the latter of these that the present disclosure focuses, to aid the clarity and conciseness of the disclosure, but the techniques described should not be considered to be limited to such an application. Instead, it is considered that the techniques may be applied to imitation learning for a wide range of applications, and may indeed be applicable to other methods of machine learning.

One particular problem that is addressed by embodiments of the present disclosure is that of generating a suitable dataset for the training of such models. Training datasets may be considered unsuitable for a number of reasons; one which is considered here is that of the training data being biased towards particular sample types. For instance, a training dataset for a self-driving car which contained mostly samples of driving on a straight road may be unsuitable in that the number of samples corresponding to bends in a road are relatively limited.

This can lead to a poor performance from a model that is trained using this dataset, as the model will be extensively trained to handle certain scenarios (overfitting to that data) and barely trained to handle others (underfitting to that data). Further to this, an inadequate amount of training data for particular sample types may impact the ability of the model to learn how to handle corresponding scenarios, and the ability of the model to transfer any learning to similar scenarios. In extreme cases the under-represented data may be ignored altogether for training purposes, as the data may be considered an outlier, and therefore no training is performed on those samples.

Considering the example of training a model to play video games, training data may comprise video recordings or the like which represent the gameplay of a real player. Once trained, the model may be used for a variety of applications, including non-player character control (such as opponents for a multiplayer game) and quality control testing for an in-game environment. The selection of an appropriate dataset is important for the training process due to the variation in game mechanics; for instance, a game may comprise platforming elements and combat elements which require radically different approaches by a player. Similarly, there may be a balance between the micro and macro elements of the gameplay; these can lead to different actions being taken in response to apparently similar game states. Factors such as these can lead to difficulties in generating suitable datasets for training.

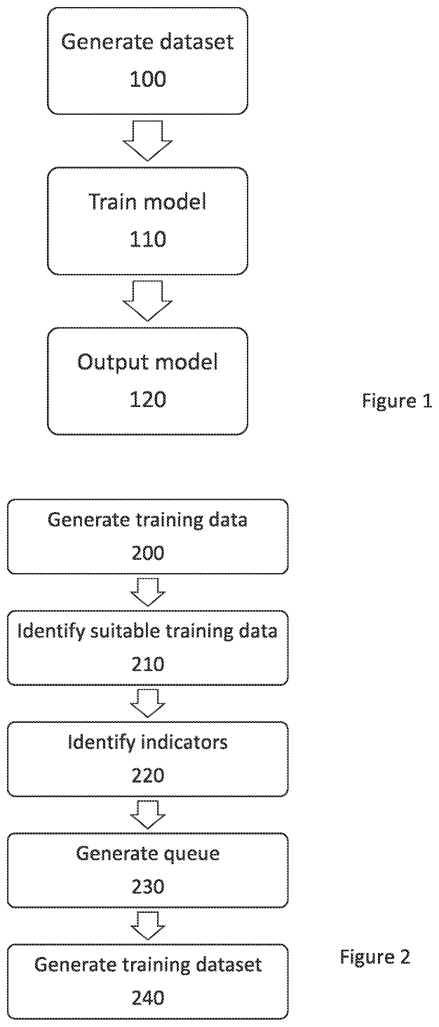

FIG. 1 schematically illustrates a method for training a machine learning model. Such a method may be implemented by a single device, such as a personal computer or games console, or respective steps or portions of steps may be performed by different devices. For instance, one or more games consoles could be used to generate a dataset while a server or personal computer performs the training of the model.

A step 100 comprises generating a training dataset for use in training the machine learning model. This step may include both the gathering of samples (such as obtaining images for training an image classification model) and/or selecting a subset of samples to be used for training (that is, select a training dataset from the available samples). In the example of an image classification process, this may comprise the selecting of images of objects (such as cats and dogs) to be differentiated between from a database comprising a larger set of images (such as a catalogue of images of animals). In the case of training a model for a particular behaviour, this may include the selection of relevant video data from a database of video clips—such as videos of a particular game from a streaming website, for instance, or videos of a particular vehicle being driven.

A step 110 comprises training the machine learning model using the training dataset generated in step 100. Any appropriate training method may be applied at this stage; this may be selected in dependence upon the type of machine learning model being implemented, or the purpose of the model may be used to inform the process and selection of model. In the case of imitation learning, the training process may include the exposure of a model to particular behaviour (such as videos of expert gameplay) and attempting to replicate that behaviour, and optionally querying of the inventor by the model and/or the provision of rewards to the model in a reinforcement-based approach.

A step 120 comprises outputting the trained machine learning model for use, and optionally using the trained machine learning model. For instance, this may comprise storing the trained model (locally, using a removable storage medium, or remotely such as at a server) and/or distributing the model. The use of the model may be by a device other than that or those used to train the model.

FIG. 2 schematically illustrates a method for generating a training dataset in accordance with embodiments of the present disclosure; this is an example of an implementation of the step 100 of FIG. 1. The method of FIG. 2 may be performed in advance of a training process, so as to generate a static training dataset that is able to be utilised at the time of training a model; alternatively, or in addition, this may be performed in real-time as a part of the training process such that the training dataset is generated at the time of training.

A step 200 comprises generating training data; as discussed above, this may include any generating or otherwise obtaining samples of expert or target behaviour. In the case of training a model to generate behaviour relevant to playing a video game, this may include generating videos of gameplay or other information indicating the actions taken by a player and the resulting impact—for instance, a log of inputs and game states that can be output and used to recreate the game state. Alternatively, or in addition, the training data may include images of a scene in a game along with context and/or user inputs to determine events within the content corresponding to the screenshot. For instance, a screenshot could be associated with an ‘attack’ input, indicating that the screenshot likely shows an enemy or other context under which an attack action may be expected.

A step 210 comprises identifying parts of the training data suitable for use as a part of the training dataset. This step may of course be considered optional in the case in which all of the generated training data is considered relevant. One example of an implementation of this step is to filter out training data which corresponds to player errors or mistakes, or otherwise poor gameplay (for instance, samples which include a death of a character controlled by the player); alternatively, or in addition, this may include filtering out other undesirable behaviour for a trained model such as showboating or timewasting.

In a step 220, indicators of behaviour are identified, and a relative frequency of these behaviours (and/or indicators) is determined. Indicators of behaviour are considered to be any features of the training data that can be used to characterise or identify the behaviour being exhibited. The indicators of behaviour may be predefined (such as identifying that use of the attack button is an indicator of a battle with an enemy), or may be learned—for instance through the labelling of content by a human to indicate events, and indicators being derived based upon a correspondence between these labels and a game state or provided input.

Similarly, the relative frequency may be predefined (such as by a games developer or experienced player) or learned through any suitable process (such as the labelling described above). This relative frequency may be calculated, or it may be an estimation of the relative frequency (that is, no exact determination of the relative frequency is performed). In some embodiments, it may be considered that samples in the training data are analysed to identify the frequency of the occurrence of the behaviours and/or indicators; for instance, by performing an event detection or through examining an input log which indicates each time a user provides a particular input. While in some cases the relative frequency may be determined for a specific set of training data (or even a particular sample within the training data), in other cases it may be determined for the corresponding content as a whole—for instance, if the training data corresponds to a single level of a game, the relative frequency may still be determined based upon the relative frequency of behaviour within the game or a group of levels as a whole.

In addition to this relative frequency of the behaviours and/or indicators, a weighting may be applied which is indicative of a preference or value of a particular behaviour for training so as to generated a weighted relative frequency. For instance, it may be considered in some cases that it would be advantageous to focus on training a model for combat encounters within a game rather than exploring—and in such a case, the relative frequency of corresponding behaviour and/or indicators may be modified to reflect this. The weighting that is applied may be determined in dependence upon a particular implementation, but in this described example it is considered that the weighting is selected so as to reduce the apparent relative frequency relative to other behaviours and/or indicators (and/or also increase the relative frequency of these). This weighting may instead be applied by modifying the probabilities used for the queue generation directly; these probabilities are discussed below.

A step 230 comprises generating a queue representing a subset of the identified parts of the training data. Here, the queue is a list of samples of behaviour that are to be provided to the model for training purposes. The queue may comprise information about events within the sample, which allows the sample to be reviewed at a particular timestamp or the like, or the queue may comprise portions of the training data itself in the form of video clips and/or game state information or the like. The samples of the training data may be obtained with any suitable degree of granularity—in some cases, the moment an input is provided may be considered to be the sample, while in others a sample may comprise content preceding and/or following this moment (such as a video or data representing a set of sequential game states).

The queue is generated by performing a probabilistic sampling of the training data, in which the probability of a particular sample being added to the queue being inversely proportional to the relative frequency (weighted or otherwise) of the behaviour and/or indicator to which the sample corresponds.

For instance, in an open-world game in which travelling may take up a lot of the player's time in-game it may be considered that enemy encounters are relatively rare despite the clear importance of such an aspect of the game. Inputs relating to the travelling (such as a run button) may therefore be assigned a low probability (such as one percent) of being added to the queue while inputs relating to the enemy combats (such as an attack button) may be assigned a high probability (such as eighty percent) of being added to the queue. In this manner, a queue can be formed which samples the training data in a non-uniform and random manner.

This may be considered advantageous in that the queue is representative of a range of different behaviours, thereby reducing the likelihood of oversampling some behaviours and undersampling others and as a result enabling a diverse set of behaviours to be obtained for training a model upon. In addition to this, the queue will be different each time it is generated even if the same training dataset is used—this can therefore enable a number of different training processes to be performed using the same training dataset. This can therefore allow a number of different iterations of training to be performed with a single dataset, and/or a number of different models to be trained using the same dataset with a reduced likelihood of the different models converging too closely.

A step 240 comprises generating a training dataset comprising the subset of identified parts of the training data; optionally, this may be in addition to further training data that is obtained from the training data generated in step 200. In other words, a random sampling of the training dataset may be performed with the sampling represented by the queue being used to supplement this data—this can balance the advantages of a large set of training samples with those of a targeted set of training samples.

In some embodiments, the queue itself may be sampled to identify a subset of training samples that are to be provided to the model; this can further increase the variation between the training datasets generated from the same initial training data. This may be a uniform sampling, rather than a weighted sampling, as the queue itself would be expected to have a more balanced distribution of types of training sample (that is, a more even split of different events or the like upon which the training is to be performed) than the initial training data.

The method of FIG. 2 therefore enables the generation of a training dataset which provides a more balanced representation of the training data in respect of the different events or behaviours that are present in that training data. In other words, more common behaviour and less common behaviour present in the training data are represented in the generated training dataset in relative quantities different to that in which they are present in the training data—a first behaviour that is twice as common as a second behaviour in the training data may be no more common in the training dataset, for instance.

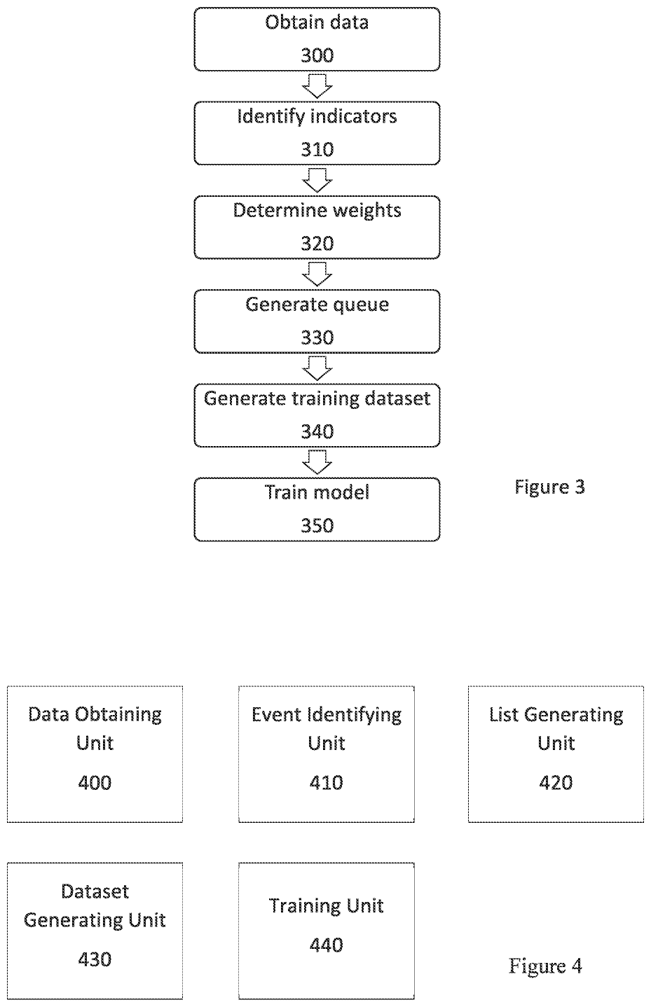

FIG. 3 schematically illustrates an example of the method of FIG. 2 as applied to the specific implementation of training a machine learning model to play a video game. While this discussion relates to the training of a machine learning model for video game behaviour, the teaching below may be extended to the training of any behaviour independent of the context as this can be achieved by varying the training data and the parameters of the queue generation without significant modification to the discussed method itself.

A step 300 comprises obtaining data of a game session of one or more players playing the game; these players may be experts (such as a high-level players), or may be selected as their gameplay represents another target behaviour—such as that of typical users, or users having a particular playstyle. This data may be generated specifically for training, or it may be obtained from existing data sources such as recordings of gameplay and/or online streams.

A step 310 comprises identifying one or more indicators of events or behaviour within the game and/or the game session(s) obtained in step 300. In some embodiments, these may be particular inputs from a user or specified actions by an avatar of the user; alternatively, or in addition, in-game events or game states may be used as an indicator. Any of these may be recognised based upon data directly representing these indicators (such as input data from a user's controller, or game state information output by the game); alternatively, or in addition, these may be inferred from image or audio analysis of the game content or the like. For instance, rather than detecting an ‘attack’ input that is input at the user's controller, image processing may be performed on game images to detect the motion of a weapon held by the user's avatar.

A step 320 comprises determining a weighting for the sampling of the obtained data, with the weighting being used for generating the queue of training data. This weighting may be determined on the basis of both the frequency of events/behaviour in gameplay and their importance to the training model.

To provide a specific example, in one implementation the player's inputs are monitored as indicators of behaviour within the game. The relative frequencies of the respective inputs are determined for the game (instance, based upon a number of samples of earlier gameplay) so as to identify which inputs are common and which are not. An example of inputs and relative frequencies is provided below to aid the discussion; of course, these should not be regarded as limiting in that they are not determined for a specific game. These frequencies may be normalised (such that the relative frequency sums to one), or may be raw numerical values that are able to be compared.

| Label | Input | Action | Relative frequency |
|---|---|---|---|
| A | Up Arrow | Move forwards | 0.5 |
| B | Down Arrow | Move backwards | 0.05 |
| C | Left Arrow | Move left | 0.1 |
| D | Right Arrow | Move Right | 0.1 |
| E | X | Jump | 0.05 |
| F | O | Attack | 0.01 |
| G | X + O | Jump Attack | 0.001 |

Based upon these exemplary numbers, it can be seen that the most common action is that of moving forwards, while the least common is the combination of jump and attack. It would therefore be expected that using such gameplay as an input for training a model, either in its entirety or using a random sampling of the gameplay, the bulk of the training data would correspond to a user moving forwards and generally navigating (also based upon the frequency of moving left, right, and backwards). This may result in a model that is very well-trained for navigation, but not for actions such as jumping, attacking, or performing a jumping attack. These additional actions may be of particular significance in content, as these are often where the difficulty in the gameplay lie rather than in simply navigating an environment.

The table below shows two exemplary schemes for implementing a weighted sampling for these actions so as to provide an improved sampling of the training data. The value shown in the weighted sampling columns reflect the probability that a given instance of the corresponding input (such as a particular press of the up arrow) is sampled. As discussed above, the sampling may consist of outputting corresponding video, image, and/or game state data for that input to the queue or model.

| | Relative | Weighted | Weighted |
|---|---|---|---|
| Label | frequency | Sampling A | Sampling B |
| A | 0.5 | 0.002 | 0.002 |
| B | 0.05 | 0.02 | 0.002 |
| C | 0.1 | 0.01 | 0.002 |
| D | 0.1 | 0.01 | 0.002 |
| E | 0.05 | 0.02 | 0.1 |
| F | 0.01 | 0.1 | 0.8 |
| G | 0.001 | 1 | 0.8 |

Weighted sampling A is an example of a sampling scheme in which it is preferred that each of the inputs is equally likely to be sampled—every instance of input G is sampled, while only one in a hundred instances of inputs C and D are sampled, and only one in five hundred instances of input A are sampled. In this case, the generated queue would be expected to represent each action in approximately equal quantities; the ‘approximately’ here reflects the fact that the specific gameplay being analysed may not entirely conform to the relative frequencies as these may correspond to particular players and/or the content as a whole (rather than the particular portion of gameplay being analysed).

Weighted sampling B is an example of a sampling scheme in which it is preferred that each of the inputs has a likelihood of being sampled which is dependent upon the significance or importance of that input. In this example, inputs B, C, and D have a reduced rate of sampling (relative to weighted sampling A) while both inputs E and F have a higher rate of sampling to reflect the importance of both jumping and attacking within the context of the game. For instance, this may reflect the fact that navigation is generally simple in that particular game but that jumping is frequently required to overcome obstacles and that fighting is the main source of difficulty (and therefore this should be the focus of the training of the model to result in a successful output for the model). The sampling rate of input G has been reduced, despite the low frequency, as it is considered that it may be an edge case that is generally not of particular use when training the model (for instance, if it is only used to combat extremely rare flying enemies) and as such excessive training for this input may lead to a reduced performance of the trained model.

Weighting schemes may be defined freely for a given implementation so as to reflect the constraints which are associated with particular behaviours to be learned as well as variations in the generation of the training dataset. For instance, in the case in which the samples in the generated queue are supplemented with a random (or other) sampling of the training data there may be an even greater emphasis on rarer actions as these are likely to be even less well-represented in the final training dataset that is generated due to the random sampling being biased towards the more common behaviours within the training data.

While the above discussion relates to the definition of static weightings, in some cases the weightings may be updated on-the-fly such that the probabilities of respective events being sampled is dynamic through the training dataset generation process. Such updates of the weightings may be made in accordance with the number of events of each type that have been added to the list—for instance, if a particular input is underrepresented despite the weightings (for instance, due to multiple instances not being added to the queue despite a high probability) then the probability may be increased to address this. For instance, a record may be kept of instances of the input and additions to the queue, and the weightings may be adjusted so as to converge towards a sampling rate that is consistent with the initial weighting that was defined.

In some embodiments, it is expected that the sampling is accompanied by a non-weighted sampling of the content so as to increase the size of the training dataset. In such cases, common events (such as input A) may not be sampled at all with the focus instead being on sampling rarer events—in other words, inputs A, C, and D may be assigned a sampling probability of zero or simply omitted from the list of weightings entirely.

A step 330 comprises generating a queue of training data relating to particular events or behaviour as identified by the detected indicators of step 310. The generation of the queue comprises sampling the content obtained in step 300 in accordance with the weighting of step 320—as noted above, the queue may comprise any suitable data for representing a game state (such as state information for the game, videos, images, event logs, and/or user input logs) and/or information which enables that data to be obtained (such as information identifying a particular portion of particular data, such as a timestamp in a video of gameplay).

In some implementations, the generation of the queue can be considered to comprise a step of identifying events in the training data (such as particular inputs), and then submitting these events to the queue with a probability based upon the values assigned to those events by the weighting described with reference to step 320.

A step 340 comprises generating a training dataset comprising the training data in the queue. This may be performed by collating the samples indicated by the queue generated in step 330 into a format that is suitable for use in training a machine learning model, for example. In some embodiments, the step 340 also comprises obtaining further samples to supplement the training dataset—for instance, through a random sampling of the training data.

A step 350 comprises training the machine learning model using the training dataset generated in step 340. As noted above, several training datasets may be generated from the same training data—as such steps 330 and 340 may be repeated any number of times to generate additional training datasets (or to generate a single, larger dataset in which some data may be repeated) which can also be used for training in this step.

Once trained, the machine learning model can be used to play a game without further user input—for instance, to playtest or benchmark a game in terms of performance or difficulty, or to provide opponents for human players. It is therefore considered that the method of FIG. 3 enables the generation of a machine learning model which is able to effectively produce behaviour comparable to that of human players through a behaviour-based learning process, despite challenges arising from the varying presence of respective behaviours in the obtained training data.

In some embodiments, it is considered that feedback or additional samples may be requested as a part of the training process; for instance, if a particular type of event is underrepresented by the training dataset, then additional training for this type of event may be provided by generating additional training data (such as requesting an expert player records more gameplay) or by resampling the additional data. This resampling may include a modification of the weightings so as to increase the likelihood of that type of event being sampled; alternatively, it may be considered that the weightings are to remain the same on the basis that due to the random nature of the sampling, different portions of the training data would be sampled so new data for that event would be present in the updated training dataset and therefore this underrepresentation may be addressed without such a change.

FIG. 4 schematically illustrates a system for generating and using a training dataset for a machine learning process to obtain a trained machine learning model from training data. The system comprises a data obtaining unit 400, an event identifying unit 410, a list generating unit 420, a dataset generating unit 430, and a training unit 440. These functional units may be implements using one or more central processing units (CPUs), for example, located at one or more devices including games consoles, personal computers, and/or servers.

The data obtaining unit 400 is configured to obtain training data comprising a plurality of events of interest and the behaviour of an agent corresponding to those events. The training data may be any data which exemplifies the behaviour of an expert (or another who displays a desired or target behaviour); examples of suitable data include videos of gameplay of a game, logs of inputs provided by users, screenshots of gameplay of a game, and/or a log of events within gameplay of a game. Of course, the determination of suitable data may be informed by the behaviour that is to be taught to the machine learning model; while these examples relate to gameplay data, it is considered that equivalent data may be provided for other behaviours.

The event identifying unit 410 is configured to identify, based upon one or more corresponding indicators, the occurrence of an event of interest in the training data. The events may be considered to be any occurrence within the training data—examples for gameplay include events such as engaging in combat, an action being taken by the player, a player's character taking or dealing damage, an objective or goal being met, and/or encountering an obstacle. Of course, the events may also be more indirectly related to the player's actions—such as a particular game state being reached, a particular element being visible in the player's view of the environment, and/or an enemy spawning.

In a video game context, the indicators may comprise one or more of game parameters, user inputs, image features of the gameplay, audio features of the gameplay, and/or entries in an event log. In other words, any aspect of the player's interaction with the game or a change in the game state may be considered to be an indicator of an event. The indicators are predefined for the training data, for instance by a game developer or a user who collates the training data. Alternatively, or in addition, the event identifying unit 410 may be configured to identify indicators for events of interest based upon one or more labelled examples in the training data.

The list generating unit 420 is configured to generate a list of identified events in the training data, wherein identified events are added to the list with a probability that is inversely proportional to the frequency of the occurrence of that event within the training data. This is discussed above with reference to steps 320 and 330 of FIG. 3, in which the probabilities are determined and the list (also referred to as a queue) is generated.

The probability of adding an event to the list may additionally be proportional to a defined significance of the corresponding indicator and/or event within the training data, rather than being solely dependent upon the frequency of the indicator/event. This can enable the training dataset that is generated to emphasise behaviours that are considered important for the model to be trained upon. In some implementations it is also considered that the probabilities for respective events are updated in response to the addition of identified events to the list; this can enable a dynamic mitigation of undersampling or oversampling of particular events to be realised.

The dataset generating unit 430 is configured to generate a dataset comprising information about the events contained in the generated list. The generated dataset may comprise any suitable representation of the selected portions of the training data, including links or other identifiers to enable the training data to be located rather than storing it directly. This may be particularly advantageous in the case in which multiple datasets are generated from the same training data, as a shared repository for the training data may be provided instead of replicating the training data for each dataset.

In some implementations, the dataset generating unit 430 may be configured to generate the dataset by additionally sampling the training data obtained by the data obtaining unit. In other words, the generated dataset may comprise training data obtained from both a direct sampling and from the list generated by the list generating unit 420.

The training unit 440 is configured to train a machine learning model using the generated dataset, wherein the machine learning model is trained to generate behaviour for an agent corresponding to events within the generated dataset. In some implementations the training unit 440 is configured to train the machine learning model using an imitation learning method, however the advantages of the dataset generation process as described may be applicable in a number of other methods for training machine learning models.

In some implementations, a more iterative approach to the dataset generation may be taken so as to enable the generation of multiple datasets having different training data. To enable this, the list generating unit 420 may be configured to generate a plurality of lists of identified events in the training data, each list comprising a different set of identified events, while the dataset generating unit 430 may be configured to generate a plurality of datasets each corresponding to a respective one of the plurality of lists. In response to this, the training unit 440 is configured to use each of these datasets for training the machine learning model. This may be performed so as to generate a single dataset comprising the contents of each of (or at least a plurality) of the lists; alternatively, or in addition, the training unit 440 may be configured to use a respective subset of the plurality of datasets for training respective ones of two or more machine learning models.

The arrangement of FIG. 4 is an example of a processor (for example, a GPU, TPU, and/or CPU located in a games console or any other computing device) that is operable to generate training datasets for a machine learning process and to train a machine learning model using one or more generated training datasets, and in particular is operable to: obtain training data comprising a plurality of events of interest and the behaviour of an agent corresponding to those events; identify, based upon one or more corresponding indicators, the occurrence of an event of interest in the training data; generate a list of identified events in the training data, wherein identified events are added to the list with a probability that is inversely proportional to the frequency of the occurrence of that event within the training data; generate a dataset comprising information about the events contained in the generated list; and train a machine learning model using the generated dataset, wherein the machine learning model is trained to generate behaviour for an agent corresponding to events within the generated dataset.

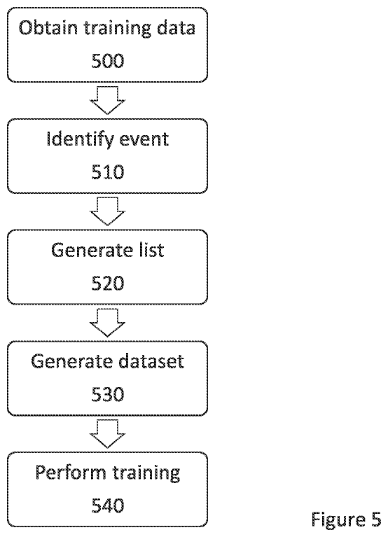

FIG. 5 schematically illustrates a method for generating a training dataset for a machine learning process and training a machine learning model in accordance with generated training datasets. This method may be implemented in accordance with any of the methods and systems described above.

A step 500 comprises obtaining training data comprising a plurality of events of interest and the behaviour of an agent corresponding to those events. This training data may include any suitable data which is able to be used to identify behaviour in a particular context; this may include any task in which an agent is intended to provide behaviour, such as the playing of video games or the control of a self-driving vehicle. The obtaining of training data may include downloading content from a server (such as videos of gameplay from a streaming server), for example, or generating the data by recoding the gameplay of an expert player.

A step 510 comprises identifying, based upon one or more corresponding indicators, the occurrence of an event of interest in the training data. These indicators may include any visual or audible elements within the data, and/or user inputs or changes in parameters within the training data (such as a change in the scores in a game), which are considered to be indicative of the occurrence of the corresponding event.

A step 520 comprises generating a list of identified events in the training data, wherein identified events are added to the list with a probability that is inversely proportional to the frequency of the occurrence of that event within the training data. As noted above, this probability may additionally be proportional to the importance of the event such that both rare and important events are added to the list with a higher relative frequency.

A step 530 comprises generating a dataset comprising information about the events contained in the generated list; this may include any suitable format of information including videos, images, and event logs. Rather than comprising this information directly, the dataset may instead (or additionally) include links or other identifiers enabling the data to be obtained.

A step 540 comprises training a machine learning model using the generated dataset, wherein the machine learning model is trained to generate behaviour for an agent corresponding to events within the generated dataset. As discussed above, in some implementations this may be an imitation learning process which is used to train the machine learning model.

The techniques described above may be implemented in hardware, software or combinations of the two. In the case that a software-controlled data processing apparatus is employed to implement one or more features of the embodiments, it will be appreciated that such software, and a storage or transmission medium such as a non-transitory machine-readable storage medium by which such software is provided, are also considered as embodiments of the disclosure.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

Embodiments of the above disclosure may be implemented in accordance with any one or more of the following numbered clauses:

1. A system for generating a training dataset for a machine learning process, and training a machine learning model, the system comprising: a data obtaining unit configured to obtain training data comprising a plurality of events of interest and the behaviour of an agent corresponding to those events; an event identifying unit configured to identify, based upon one or more corresponding indicators, the occurrence of an event of interest in the training data; a list generating unit configured to generate a list of identified events in the training data, wherein identified events are added to the list with a probability that is inversely proportional to the frequency of the occurrence of that event within the training data; a dataset generating unit configured to generate a dataset comprising information about the events contained in the generated list; and a training unit configured to train a machine learning model using the generated dataset, wherein the machine learning model is trained to generate behaviour for an agent corresponding to events within the generated dataset.

2. A system according to clause 1, wherein the training data comprises videos of gameplay of a game, logs of inputs provided by users, screenshots of gameplay of a game, and/or a log of events within gameplay of a game.

3. A system according to any preceding clause, wherein the indicators comprise one or more of game parameters, user inputs, image features of the gameplay, audio features of the gameplay, and/or entries in an event log.

4. A system according to any preceding clause, wherein the probability of adding an event to the list is additionally proportional to a defined significance of the corresponding indicator and/or event within the training data.

5. A system according to any preceding clause, wherein the dataset generating unit is configured to generate the dataset by additionally sampling the training data obtained by the data obtaining unit.

6. A system according to any preceding clause, wherein: the list generating unit is configured to generate a plurality of lists of identified events in the training data, each list comprising a different set of identified events; the dataset generating unit is configured to generate a plurality of datasets each corresponding to a respective one of the plurality of lists; and the training unit is configured to use each of these datasets for training the machine learning model.

7. A system according to clause 6, wherein the training unit is configured to use a respective subset of the plurality of datasets for training respective ones of two or more machine learning models.

8. A system according to any preceding clause, wherein the indicators are predefined for the training data.

9. A system according to any preceding clause, wherein the event identifying unit is configured to identify indicators for events of interest based upon one or more labelled examples in the training data.

10. A system according to any preceding clause, wherein the probabilities for respective events are updated in response to the addition of identified events to the list.

11. A system according to any preceding clause, wherein the training unit is configured to train the machine learning model using an imitation learning method.

12. A method for generating a training dataset for a machine learning process, and training a machine learning model, the method comprising: obtaining training data comprising a plurality of events of interest and the behaviour of an agent corresponding to those events; identifying, based upon one or more corresponding indicators, the occurrence of an event of interest in the training data; generating a list of identified events in the training data, wherein identified events are added to the list with a probability that is inversely proportional to the frequency of the occurrence of that event within the training data; generating a dataset comprising information about the events contained in the generated list; and training a machine learning model using the generated dataset, wherein the machine learning model is trained to generate behaviour for an agent corresponding to events within the generated dataset.

13. Computer software which, when executed by a computer, causes the computer to carry out the method of clause 12.

14. A non-transitory machine-readable storage medium which stores computer software according to clause 13.

1. A system for generating a training dataset for a machine learning process, and training a machine learning model, the system comprising:
a data obtaining unit configured to obtain training data comprising a plurality of events of interest and the behaviour of an agent corresponding to those events;
an event identifying unit configured to identify, based upon one or more corresponding indicators, the occurrence of an event of interest in the training data;
a list generating unit configured to generate a list of identified events in the training data, wherein identified events are added to the list with a probability that is inversely proportional to the frequency of the occurrence of that event within the training data;
a dataset generating unit configured to generate a dataset comprising information about the events contained in the generated list; and
a training unit configured to train a machine learning model using the generated dataset, wherein the machine learning model is trained to generate behaviour for an agent corresponding to events within the generated dataset.

2. The system of claim 1, wherein the training data comprises videos of gameplay of a game, logs of inputs provided by users, screenshots of gameplay of a game, and/or a log of events within gameplay of a game.

3. The system of claim 1, wherein the indicators comprise one or more of game parameters, user inputs, image features of the gameplay, audio features of the gameplay, and/or entries in an event log.

4. The system of claim 1, wherein the probability of adding an event to the list is additionally proportional to a defined significance of the corresponding indicator and/or event within the training data.

5. The system of claim 1, wherein the dataset generating unit is configured to generate the dataset by additionally sampling the training data obtained by the data obtaining unit.

6. The system of claim 1, wherein:
the list generating unit is configured to generate a plurality of lists of identified events in the training data, each list comprising a different set of identified events;
the dataset generating unit is configured to generate a plurality of datasets each corresponding to a respective one of the plurality of lists; and
the training unit is configured to use each of these datasets for training the machine learning model.

7. The system of claim 6, wherein the training unit is configured to use a respective subset of the plurality of datasets for training respective ones of two or more machine learning models.

8. The system of claim 1, wherein the indicators are predefined for the training data.

9. The system of claim 1, wherein the event identifying unit is configured to identify indicators for events of interest based upon one or more labelled examples in the training data.

10. The system of claim 1, wherein the probabilities for respective events are updated in response to the addition of identified events to the list.

11. The system of claim 1, wherein the training unit is configured to train the machine learning model using an imitation learning method.

12. A method for generating a training dataset for a machine learning process, and training a machine learning model, the method comprising:
obtaining training data comprising a plurality of events of interest and the behaviour of an agent corresponding to those events;
identifying, based upon one or more corresponding indicators, the occurrence of an event of interest in the training data;
generating a list of identified events in the training data, wherein identified events are added to the list with a probability that is inversely proportional to the frequency of the occurrence of that event within the training data;
generating a dataset comprising information about the events contained in the generated list; and
training a machine learning model using the generated dataset, wherein the machine learning model is trained to generate behaviour for an agent corresponding to events within the generated dataset.

13. A non-transitory machine-readable storage medium which stores computer software which, when executed by a computer, causes the computer to perform a method for generating a training dataset for a machine learning process, and training a machine learning model, the method comprising:
obtaining training data comprising a plurality of events of interest and the behaviour of an agent corresponding to those events;
identifying, based upon one or more corresponding indicators, the occurrence of an event of interest in the training data;
generating a list of identified events in the training data, wherein identified events are added to the list with a probability that is inversely proportional to the frequency of the occurrence of that event within the training data;
generating a dataset comprising information about the events contained in the generated list; and
training a machine learning model using the generated dataset, wherein the machine learning model is trained to generate behaviour for an agent corresponding to events within the generated dataset.
